(19) United States
(12) Patent Application Publication
(10) Pub. No.: US 2020/0208437 A1
(43) Pub. Date: Jul. 2, 2020

(54) MAGNETIC LOCKING DEVICE

(71) Applicant: GANG GWO INDUSTRIAL CO., LTD., Pingtung City (TW)

(72) Inventor: Ko-Ming CHENG, Pingtung City (TW)

(73) Assignee: GANG GWO INDUSTRIAL CO., LTD., Pingtung City (TW)

(21) Appl. No.: 16/235,748

(22) Filed: Dec. 28, 2018

(51) Int. Cl. E05B 47/00; E05B 17/20; E05C 19/16

(52) U.S. Cl. CPC E05B 47/004; E05B 17/2007; E05Y 2900/132; E05B 47/0046; E05C 19/163

(57) ABSTRACT

A magnetic locking device has a magnetic latch device mounted in a door panel and an engagement device mounted in a door frame. The magnetic latch device has a magnetic latch assembly and a locking mechanism which are mounted in a housing of the magnetic latch device. The magnetic latch assembly has a latch bolt, restoring springs providing a restoring force to the latch bolt, and a magnetized element mounted in a latch portion of the latch bolt which is protrudable from the housing. The engagement device has a magnetic attracting assembly mounted in a latching seat of the engagement device. The magnetic attracting assembly can attract the magnetized element to move into the latching seat and to attach to the magnetic attracting assembly. The latch bolt will not bump to the engagement device while the door is closing.

### BACKGROUND OF THE INVENTION

### 1. Field of the Invention

The present invention relates to a magnetic locking device, and more particularly to a magnetic locking device which is mounted in a door frame and a door panel of a door to secure and lock the door when the door is closed.

### 2. Description of Related Art

With reference to FIG. 9, a conventional locking device for a door has a latch device 90 and a latching seat 80. The latch device 90 is mounted in a door panel and has a housing 91 and a latch bolt 92. The housing 91 is mounted in the door panel. The latch bolt 92 is mounted in the housing 91 and protrudes from the housing 91. The latch bolt 92 has a beveled contact surface 93 formed on a side of the latch bolt 92 facing a door frame. The latch bolt 92 is controlled by a locking mechanism mounted in the housing 91. The locking mechanism may pull the latch bolt 92 to move into the housing 91. The latching seat 80 is mounted in the door frame and has a latching cavity 81 formed therein and corresponding to the latch bolt 92 of the latch device 90 in position.

In a normal situation, the latch bolt 92 of the latch device 90 remains protruding from the housing 91. While the door is closing, the contact surface 93 of the latch bolt 92 will bump to the latching seat 80 mounted in the door frame, and the latch bolt 92 will be pushed into the housing 91. After the latch bolt 92 is facing toward the latching cavity 81 of the latching seat 80, the latch bolt 92 will protrude from the housing 91 into the latching cavity 81 to keep the door closed. However, noise will be caused by the latch bolt 92 and the latching seat 80 bumping to each other when the door is being closed with the conventional locking device. Moreover, a pushing force is required for closing the door, so that the latch bolt 92 can be accurately engaged into the latching cavity 81 to secure the door.

To overcome the shortcomings, the present invention tends to provide a magnetic locking device to mitigate or obviate the aforementioned problems.

### SUMMARY OF THE INVENTION

The main objective of the invention is to provide a magnetic locking device. Thereby, noise caused by the latch bolt and the latching seat bumping to each other while the door is closing will be prevented, and a pushing force which is required for accurately closing the door can be decreased.

The magnetic locking device has a magnetic latch device and an engagement device. The magnetic latch device has a housing, a magnetic latch assembly and a locking mechanism. The magnetic latch assembly is mounted in the housing and has a latch bolt horizontally movably mounted in the housing and having a latch portion being protrudable from the housing, a magnetized element mounted in the latch portion of the latch bolt, and at least one restoring spring mounted in the housing and connected with the housing and the latch bolt. The locking mechanism is mounted in the housing and is connected with the latch bolt of the magnetic latch. The engagement device is engageable with the magnetic latch device and has a latching seat having a latching cavity formed therein and having an opening facing the magnetic latch device, and a magnetic attracting assembly mounted in the latching cavity of the latching seat. The magnetic attracting assembly has a magnetic element horizontally movably mounted in the latching cavity of the latching seat, and at least one pushing spring having two ends respectively abutting against an inner wall of the latching seat and the magnetic element.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a magnetic locking device in accordance with the present invention;

FIG. 2 is an exploded perspective view of the magnetic latch device of the magnetic locking device in FIG. 1;

FIG. 3 is a side view of the housing of the magnetic locking latch device in FIG. 1 when the door panel is open;

FIG. 4 is a side view of the housing of the magnetic locking device in FIG. 1 when the door panel is closed;

FIG. 5 is a side view of the housing of the magnetic locking device in FIG. 1 when the door panel is closed;

FIG. 6 is an operational side view of the magnetic locking device in FIG. 1 showing the handle rotating;

FIG. 7 is a side view of the housing of the magnetic locking device in FIG. 1 showing the engagement of the magnetic locking device;

FIG. 8 is a side view of the housing of the magnetic locking device in FIG. 1 showing the engagement of the magnetic locking device; and

FIG. 9 is a top view of a conventional locking device showing a door is closed.

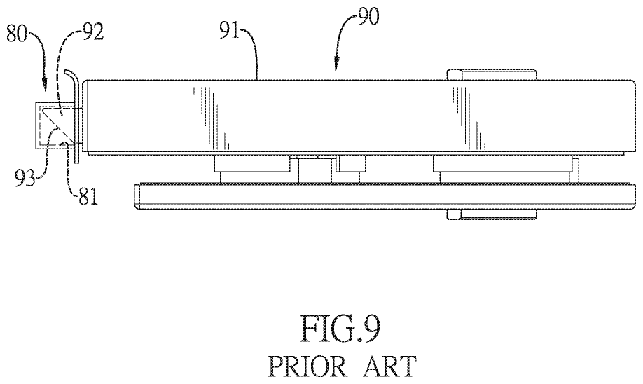

### DETAILED DESCRIPTION OF PREFERRED EMBODIMENT

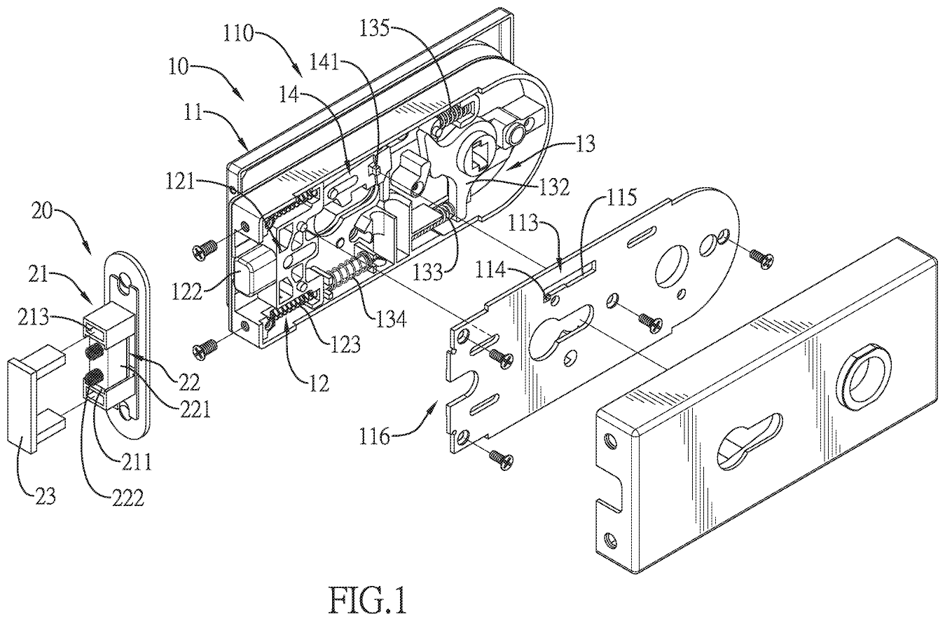

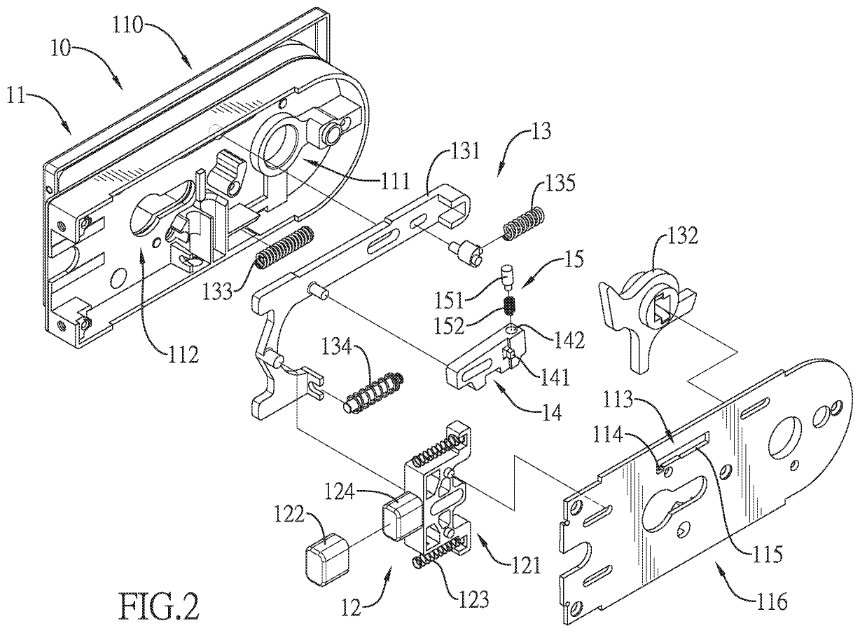

With reference to FIGS. 1 and 2, a magnetic locking device in accordance with the present invention has a magnetic latch device 10 and an engagement device 20.

With reference to FIGS. 1 and 2, the magnetic latch device 10 is mounted in a door panel and has a housing 11, a magnetic latch assembly 12, and a locking mechanism 13. The housing 11 has a base 110 and a cover 116 connected with each other. The magnetic latch assembly 12 is mounted in the housing 11 and has a latch bolt 121, a magnetized element 122, and at least one restoring spring 123. The latch bolt 121 is horizontally movably mounted in the housing 11 and has a latch portion 124. The latch portion 124 is protrudable from the housing 11. The magnetized element 122 is mounted on the latch portion 124 of the latch bolt 121. The magnetized element 122 is made of a magnetized material and may be a metal cover which is mounted around the latch portion 124 of the latch bolt 121 or a metal block mounted in the latch portion 124 of the latch bolt 121. The at least one restoring spring 123 is mounted in the housing 11, is connected with the housing 11 and the latch bolt 121, and provides a restoring force to the latch bolt 121. Preferably, the magnetic latch device 10 has two restoring springs 123 respectively deposed at opposite sides of the latch bolt 121. The locking mechanism 13 is mounted in the housing 11, is connected with the latch bolt 121 of the magnetic latch assembly 12, and may control the latch bolt 121 to move outward and inward from and to the housing 11.

With reference to FIG. 1, the engagement device 20 is mounted in a door frame, corresponds to the magnetic latch device 10 in position, is engageable with the latch device 10, and has a latching seat 21 and a magnetic attracting assembly 22. The latching seat 21 has a latching cavity 211, two cover recesses 213, and a rear cover 23. The latching cavity 211 is formed in the latching seat 21 and has an opening facing the door panel. The cover recesses 213 are recessed in the latching seat 21 and respectively located at opposite sides of the latching cavity 211. Each cover recess 213 has an opening away from the door panel. The rear cover 23 is mounted in the cover recesses 213 of the latching seat 21 to close a side of the latching cavity 211 away from the door panel. The side of the rear cover 23 facing the latching cavity 211 is formed as an inner wall of the latching seat 21. The magnetic attracting assembly 22 is mounted in the latching seat 21 and has a magnetic element 221 and at least one pushing spring 222. The magnetic element 221 is horizontally movably mounted in the latching cavity 211 of the latching seat 21. Each pushing spring 222 has two ends respectively abutting against the inner wall of the latching seat 21 and the magnetic element 221 to push the magnetic element 221 to a position near the opening of the latching cavity 211. So the magnetic element 221 can attract the magnetized element 122 of the magnetic latch assembly 12 to move into the latching cavity 211 and attach to the magnetic element 221.

With reference to FIGS. 1 and 2, the housing 11 has an assembled portion 111 which is formed in the base 110 of the housing 11 and is located at a side of the magnetic latch assembly 12. The locking mechanism 13 has a linking plate 131, a dial plate 132, a dial plate spring 133, a linking plate spring 134, and a connecting spring 135. The linking plate 131 is horizontally movably mounted in the housing 11 and is connected with the latch bolt 121 of the magnetic latch assembly 12. The dial plate 132 is rotatably mounted in the housing 11 and is disposed on the assembled portion 111 of the housing 11. The dial plate spring 133 is connected with the housing 11 and the dial plate 132 and provides a restoring force to the dial plate 132. The linking plate spring 134 is connected with the housing 11 and the linking plate 131, pushes the linking plate 131 toward the latch bolt 121, and provides a restoring force to the linking plate 131. The connecting spring 135 is connected with the linking plate 131 and the dial plate 132, and the spring constant of the connecting spring 135 is higher than the spring constant of the linking plate spring 134.

With reference to FIGS. 1 and 2, the housing 11 further has a locking portion 112 and a mounting slot 113. The locking portion 112 is formed on the base 110 of the housing 11 at a position between the assembled portion 111 and the magnetic latch assembly 12. The mounting slot 113 is formed in the cover 116 of the housing 11 and at a position near the locking portion 112. The mounting slot 113 has a locking cavity 114 and an unlocking portion 115 opposite to each other. The locking cavity 114 is recessed in an end of the mounting slot 113, and the unlocking portion 15 is defined at the other end of the mounting slot 113. The locking mechanism 13 has a locking block 14. The locking block 14 is movably mounted in the linking plate 131 and has a protrusion 141 protruding toward the cover 116 of the housing 11. The protrusion 141 is mounted in the mounting slot 113, and is slidable between the locking cavity 114 and the unlocking portion 115 of the mounting slot 113. The locking block 14 may be moved by a lock core mounted in the locking portion 112 of the housing 11 to slide the protrusion 141 between the locking cavity 114 and the unlocking portion 115 of the mounting slot 113.

With reference to FIGS. 1 and 2, the locking mechanism 13 has a pusher assembly 15 mounted in the locking block 14. The pusher assembly 15 abuts against the housing 11. The locking block 14 may further have a cavity 142. The pushing assembly 15 has a pusher 151 and a pusher spring 152. The pusher 151 is movably mounted in the cavity 142. The pusher spring 152 is mounted in the cavity 142 and is connected with the pusher 151 and the locking block 14.

The magnetic locking device in accordance with the present invention may be mounted in the door panel and the door frame of a door and is applied to secure and lock the door when the door is closed. The magnetic latch device 10 may be connected with a handle which is connected with the dial plate 132 of the locking mechanism 13.

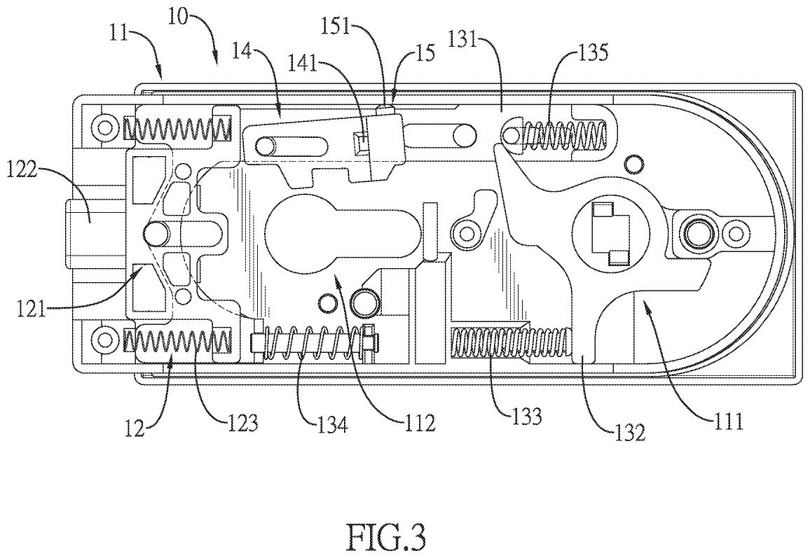

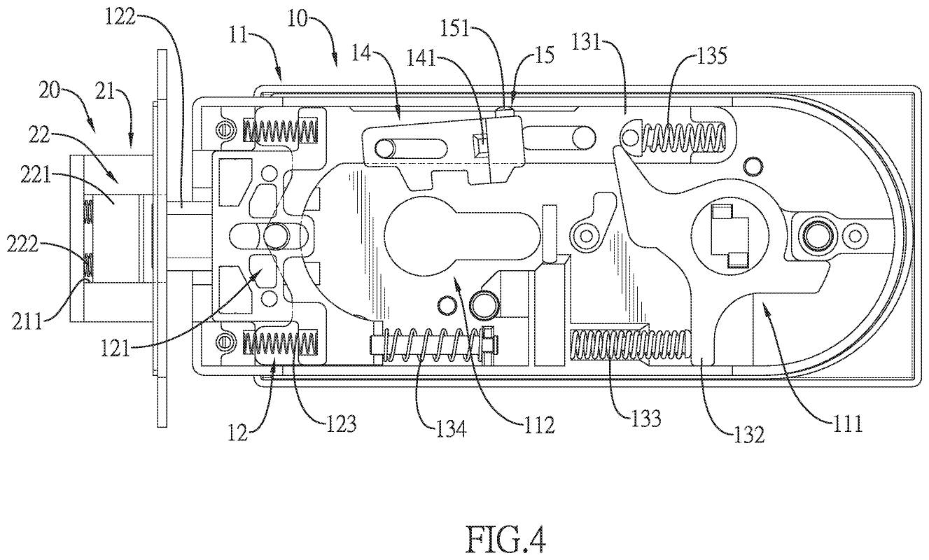

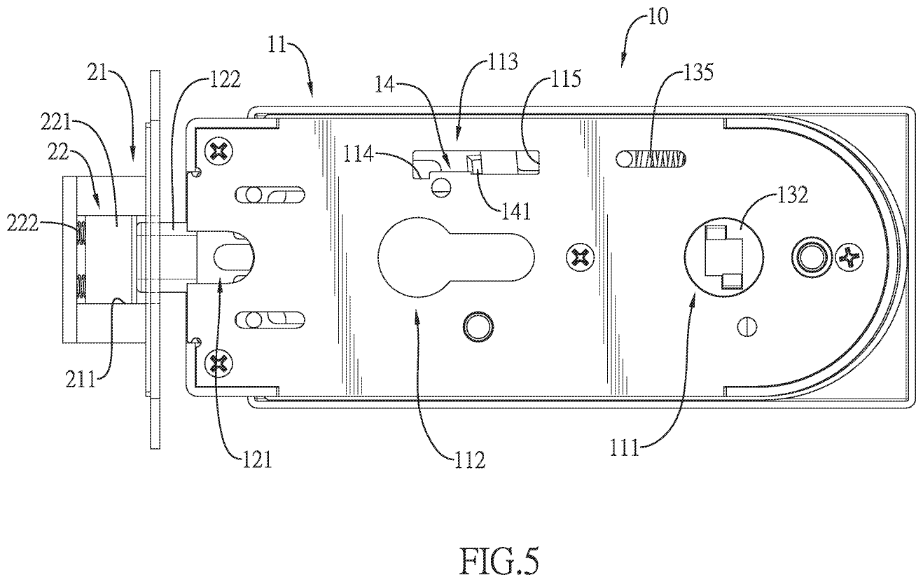

With reference to FIG. 3, when the door is open, the restoring springs 123 will push the latch bolt 121 to stay inside the housing 11. With reference to FIGS. 4 and 5, after the door is closed, the magnetized element 122 mounted in the latch portion 124 of the latch bolt 121 will face toward the magnetic element 221 of the engagement device 20. At this time, the magnetic element 221 will attract the magnetized element 122, and the latch bolt 121 will resist the restoring force of the restoring springs 123 and will move outward from the housing 11. The magnetized element 122 will move into the latching cavity 211 of the engagement device 20 and will attach to the magnetic element 221. Therefore, the latch portion 124 of the latch bolt 121 will be engaged with the latching cavity 211 of the engagement device 20 to keep the door closed.

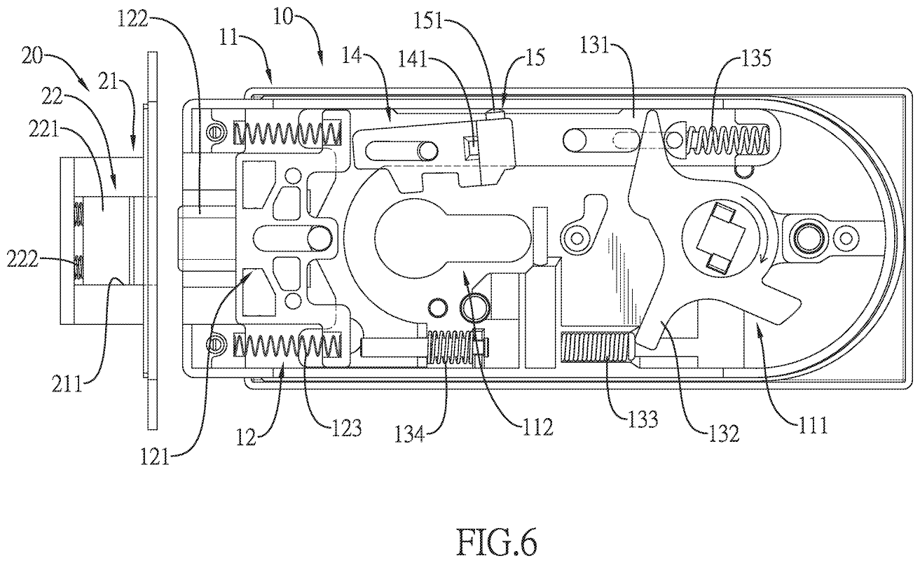

With reference to FIG. 6, to open the door, the dial plate 132 may be rotated by turning the handle. The dial plate 132 will push the dial plate spring 133 while rotating. The linking plate spring 134 keeps pushing the linking plate 131 toward the magnetic latch assembly 12, and the connecting spring 135 pushes the linking plate 131 away from the magnetic latch assembly 12 while the dial plate 132 is rotating. Because the spring constant of the connecting spring 135 is higher than the spring constant of the linking plate spring 134, the connecting spring 135 can provide a force larger than that provided by the linking plate spring 134 to push the linking plate 13. So the linking plate 131 will be pushed away from the engagement device 20 by the force difference between the connecting spring 135 and the linking plate spring 134. While moving, the linking plate 131 will pull the latch bolt 121 to slide out of the latching cavity 211 and retract into the housing 11. At this moment, the door may be opened by pulling the door panel. After releasing the handle, the dial plate spring 133 will push the dial plate 132 to return to the original position, and the linking plate spring 134 will push the linking plate 131 to return to the original position.

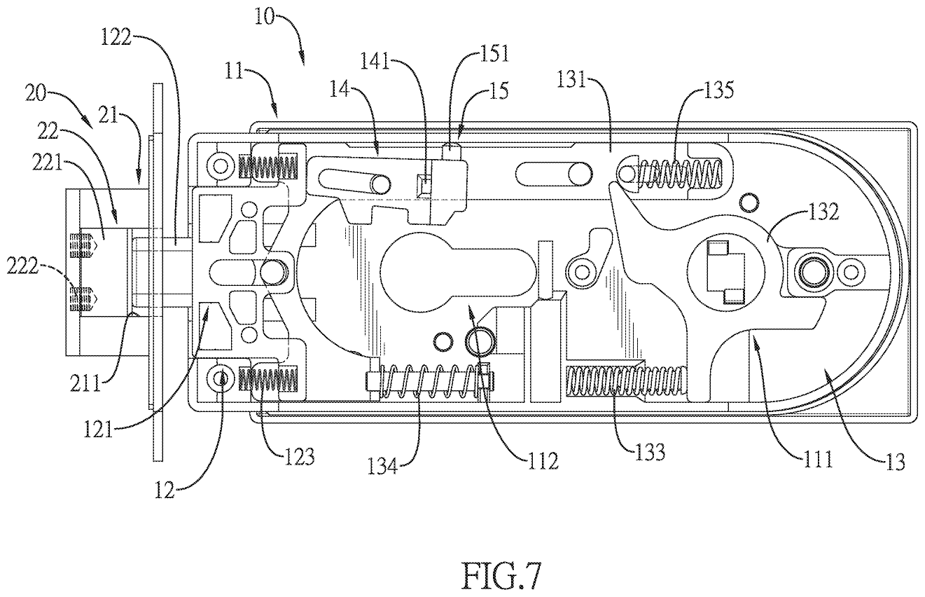

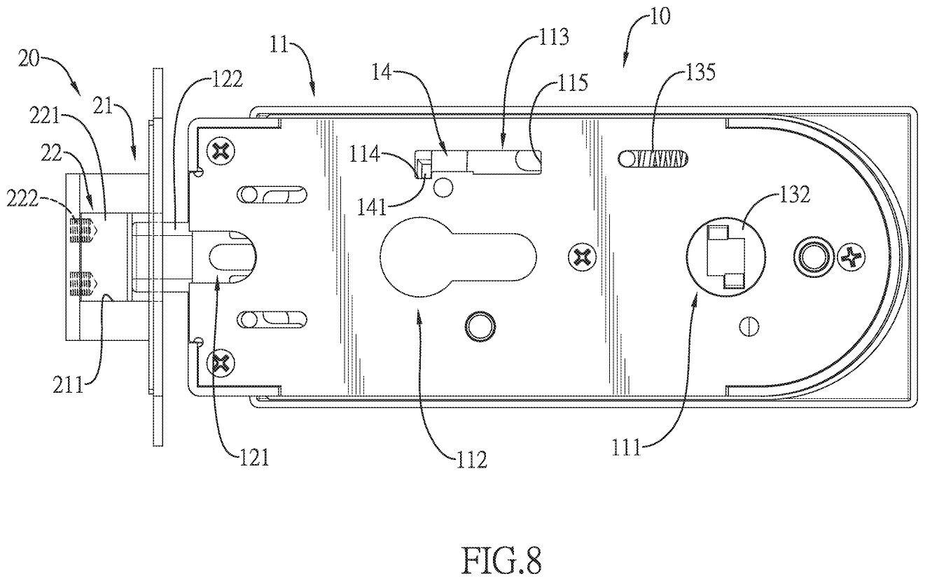

With reference to FIGS. 7 and 8, to lock the door, the lock core may be driven by turning a key inserted therein. The lock core will slide the locking block 14 toward the engagement device 20. While moving, the locking block 14 will push the latch bolt 121 to move into the latching cavity 211 and to abut against the magnetic element 221 to move into the latching cavity 211 from the opening of the latching seat 21. The protrusion 141 will slide from the unlocking portion 115 to the locking cavity 114 of the mounting slot 113 at the same time. The pusher assembly 15 will push the locking block 14, so that the protrusion 141 of the locking block 14 will be engaged in the locking cavity 114 of the mounting slot 113. The locking block 14 will abut against and restrict the lock bolt 121 to keep the door locked.

With reference to FIGS. 4 and 5, to unlock the door, the lock core may be driven by reversing the key. The lock core will slide the locking block 14 away from the engagement device 20. At this moment, the protrusion 141 will slide from the locking cavity 114 to the unlocking portion 115 of the mounting slot 113. The locking block 14 will be separated from the latch bolt 121. The pushing spring 222 of the magnetic attracting assembly 22 will push the magnetic element 221 to the position near the opening of the latching cavity 211. The latch bolt 121 can be separated from the latching cavity 211 of the engagement device 20 to open the door by turning the handle.

The magnetic latch device 10 in accordance with the present invention has the following advantages and improvements:

1. Noise will be reduced while closing the door. When the door is not closed, the restoring springs 123 will push the latch bolt 121 to stay inside the housing 11. After the door is closed, the magnetized element 122 mounted in the latch portion 124 of the latch bolt 121 will be attracted by the magnetic element 221 of the engagement device 20 to move into the latching cavity 211 and to attach to the magnetic attracting assembly 22. Therefore, the latch bolt 121 will not bump to the engagement device 20 while the door is closing, and noise will be reduced.

2. The pushing force for closing the door will be reduced. As mentioned above, the latch bolt 121 will stay inside the housing 11 before closing the door. After the door is closed, the magnetized element 122 will move into the latching cavity 211 by magnetic attraction of the magnetic attracting assembly 22 to prevent the latch bolt 121 from bumping to the engagement device 20 while the door is closing. After the door is closed, the latch bolt 121 will be moved in and engaged in the latching cavity 211 accurately to secure the door by magnetic attraction of the magnetic attracting assembly 22 and the magnetized element 122, and the pushing force for closing the door can be reduced.

What is claimed is:

1. A magnetic locking device comprising:
a magnetic latch device having;
a housing;
a magnetic latch assembly mounted in the housing and having
a latch bolt horizontally movably mounted in the housing and having
a latch portion being protrudable from the housing;
a magnetized element mounted in the latch portion of the latch bolt; and
at least one restoring spring mounted in the housing and connected with the housing and the latch bolt; and
a locking mechanism mounted in the housing and connected with the latch bolt of the magnetic latch assembly; and
an engagement device being engageable with the magnetic latch device and having
a latching seat having a latching cavity formed therein and having an opening facing the magnetic latch device; and
a magnetic attracting assembly mounted in the latching cavity of the latching seat and having
a magnetic element horizontally movably mounted in the latching cavity of the latching seat; and
at least one pushing spring having two ends respectively abutting against an inner wall of the latching seat and the magnetic element.

2. The magnetic locking device as claimed in claim 1, wherein
the locking mechanism has
a linking plate horizontally movably mounted in the housing and connected with the latch bolt of the magnetic latch assembly;
a dial plate rotatably mounted in the housing;
a dial plate spring connected with the housing and the dial plate;
a linking plate spring connected with the housing and the linking plate; and
a connecting spring connected with the linking plate and the dial plate and having a spring constant higher than a spring constant of the linking plate spring.

3. The magnetic locking device as claimed in claim 2, wherein
a mounting slot is formed in the housing, and has a locking cavity and an unlocking portion respectively formed in two ends of the mounting slot; and
the locking mechanism has
a locking block slidably mounted in the linking plate and having
a protrusion mounted in the mounting slot and being slidable between the locking cavity and the unlocking portion of the mounting slot.

4. The magnetic locking device as claimed in claim 3, wherein the locking mechanism has
a pusher assembly mounted in the locking block and abutting against the housing.

5. The magnetic locking device as claimed in claim 4, wherein the locking block has a cavity; and
the pusher assembly has
a pusher movably mounted in the cavity; and
a pusher spring mounted in the cavity and connected with the pusher and the locking block.
